(19) United States
(12) Patent Application Publication
(10) Pub. No.: US 2014/0260224 A1
(43) Pub. Date: Sep. 18, 2014

(54) Control System for Variable Displacement Hydraulic Motor

(71) Applicant: CLARK EQUIPMENT COMPANY, West Fargo, ND (US)

(72) Inventors: Jeremy Aaron Harms, Bismarck, ND (US); Daniel James Krieger, Bismarck, ND (US)

(73) Assignee: CLARK EQUIPMENT COMPANY, West Fargo, ND (US)

(21) Appl. No.: 13/830,904

(22) Filed: Mar. 14, 2013

(51) Int. Cl. F16H 61/421

(52) U.S. Cl. CPC F16H 61/421
USPC 60/327; 60/445; 60/443

(57) ABSTRACT

A control system for a variable displacement hydraulic motor. A movable element is movable to adjust the operating displacement of hydraulic fluid through the motor. A positioning actuator moves the movable element between first and second positions to cause maximum and minimum operating displacement of the motor. A range limiting actuator positions a movable stop in a desired position, such that the movable stop interengages the movable element to cause motor displacement between the maximum and minimum operating displacements. The control system thus operates the motor in at least three modes: maximum operating displacement; minimum operating displacement; and an intermediate operating displacement.

### BACKGROUND

This disclosure relates to a control system for a variable displacement hydraulic motor. One specific application for the control system is a control system for a variable displacement hydraulic drive motor for a power machine. Power machines, for the purposes of this disclosure, include any type of machine that generates power for the purpose of accomplishing a particular task or a variety of tasks. One type of power machine is a work vehicle. Work vehicles are generally self-propelled vehicles that have a work device, such as a lift arm (although some work vehicles can have other work devices) that can be manipulated to perform a work function. Some examples of work vehicle power machines include loaders, excavators, utility vehicles, tractors, and trenchers, to name a few.

Many power machines, including some of the work vehicles listed above, employ hydraulic motors to perform work functions, including providing a driving force for propelling a power machine over a support surface. In other power machine applications, a hydraulic motor may be employed to perform other tasks, including tasks performed on an implement that is operatively coupled to the power machine. By employing a variable displacement hydraulic motor, various torque/speed arrangements can be advantageously employed in various operating conditions.

The discussion above is merely provided for general background information and is not intended to be used as an aid in determining the scope of the claimed subject matter.

### SUMMARY

One disclosed embodiment of the present disclosure provides a control system for a variable displacement hydraulic motor. The control system includes a movable element that is movable in a range of motion between a first position and a second position. One of the first and second positions corresponds to a maximum operating displacement of hydraulic fluid through the motor and the other of the first and second positions corresponds to a minimum operating displacement of hydraulic fluid through the motor. A positioning actuator moves the movable element through the range of motion from the first position toward the second position. A movable stop is movable to a selected position for interengagement with the movable element to resist movement of the movable element past an intermediate position between the first and second positions. The intermediate position of the moveable element corresponds to an intermediate operating displacement of hydraulic fluid through the motor. A range limiting actuator moves the movable stop to the selected position; and a position controller controls the operation of the range limiting actuator.

Another embodiment provides for a power machine having a power source, a power conversion system converting power from the power source into flow of a hydraulic fluid, and a drive system utilizing the hydraulic fluid to move the power machine between locations. The drive system includes a variable displacement drive motor and a drive motor control system. The drive motor control system includes a movable element that is movable in a range of motion between a first position and a second position. One of the first and second positions corresponds to a maximum operating displacement of hydraulic fluid through the motor and the other of the first and second positions corresponds to a minimum operating displacement of hydraulic fluid through the motor. A positioning actuator moves the movable element through the range of motion from the first position toward the second position. A movable stop is movable to a selected position for interengagement with the movable element to resist movement of the movable element past an intermediate position between the first and second positions. The intermediate position of the movable element corresponds to an intermediate operating displacement of hydraulic fluid through the motor. A range limiting actuator moves the movable stop to the selected position and a position controller controls the operation of the range limiting actuator.

Another embodiment provides for a method for operating a variable displacement hydraulic motor that includes a movable element that is movable to a first position to operate the motor at maximum operating displacement of hydraulic fluid through the motor and a second position to operate the motor at minimum operating displacement of hydraulic fluid through the motor. The method includes providing a displacement control input and in response to a first level of the displacement control input, shifting the movable element to the first position, such that the motor operates in a high torque, low speed mode. In response to a second level of the displacement control input, the movable element is shifted to the second position, such that the motor operates in a low torque, high speed mode. In response to a third level of the displacement control input between the first and second levels, a movable stop is positioned to resist movement of the movable element past a third position between the first and second positions, such that the motor operates in an intermediate torque, intermediate speed mode.

This Summary and the Abstract are provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a side elevation view of a representative power machine of the type that can employ variable displacement motors and a control system described in the disclosed embodiments for providing a power source to the variable displacement motors.

FIG. 2 is a block diagram illustrating a system for employing variable displacement motors according to one illustrative embodiment.

FIG. 3 is a schematic illustration of a variable displacement hydraulic motor and a control system therefor with the control system in a first condition according to one illustrative embodiment.

FIG. 4 is a schematic illustration of the variable displacement hydraulic motor and control system of FIG. 3, with the control system in a second condition.

FIG. 5 is a schematic illustration of the variable displacement hydraulic motor and control system of FIG. 3, with the control system in a third condition.

FIG. 6 is a flowchart describing a method of operation of the control system of FIG. 2 according to one illustrative embodiment.

### DETAILED DESCRIPTION

The concepts disclosed herein are not limited in their application to the details of construction and the arrangement of components set forth in the following description or illustrated in the following drawings. That is, the embodiments disclosed herein are illustrative in nature. The concepts illustrated in these embodiments are capable of being practiced or being carried out in various ways. The terminology used herein is for the purpose of description and should not be regarded as limiting. Words such as “including,” “comprising,” and “having” and variations thereof as used herein are meant to encompass the items listed thereafter, equivalents thereof, as well as additional items.

FIG. 1 is a side elevation view of a representative power machine 100 upon which the disclosed embodiments can be employed. The power machine 100 illustrated in FIG. 1 is a work vehicle in the form of a skid-steer loader, but other types of work vehicles such as tracked loaders, steerable wheeled loaders, including all-wheel steer loaders, excavators, telehandlers, walk behind loaders, trenchers, and utility vehicles, as well as other power machines, may employ the disclosed embodiments. The power machine 100 includes a supporting frame or main frame 102, which supports a power source 104, which in some embodiments is an internal combustion engine. A power conversion system 106 is operably coupled to the power source 104. Power conversion system 106 illustratively receives power from the power source 104 and operator inputs to convert the received power into power signals in a form that is provided to and utilized by functional components of the power machine. In some embodiments, such as with the power machine 100 in FIG. 1, the power conversion system 106 includes hydraulic components such as one or more hydraulic pumps and various actuators and valve components that are illustratively employed to receive and selectively provide power signals in the form of pressurized hydraulic fluid to some or all of the actuators used to control functional components of the power machine 100. Alternatively, the power conversion system 106 can include electric generators or the like to generate electrical control signals to power electric actuators. For the sake of simplicity, the actuators discussed in the disclosed embodiments herein are referred to as hydraulic or electrohydraulic actuators primarily in the form of motors and cylinders, but other types of actuators can be employed in some embodiments.

Among the functional components that are capable of receiving power signals from the power conversion system 106 are tractive elements 108, illustratively shown as wheels, which are configured to rotatably engage a support surface to cause the power machine to travel. Other examples of power machines can have tracks or other tractive elements instead of wheels. In an example embodiment, a pair of hydraulic motors (not shown in FIG. 1), are provided to convert a hydraulic power signal into a rotational output. In power machines such as skid-steer loaders, a single hydraulic motor can be operatively coupled to both of the wheels on one side of the power machine. Alternatively, a hydraulic motor can be provided for each tractive element to allow for independent drive control for each tractive element on a machine. Steering a skid-steer loader is accomplished by providing unequal rotational outputs to the tractive element or elements on one side of the machine as opposed to the other side. In some power machines, steering is accomplished through other means, such as, for example, steerable axles or articulating frames.

The power machine 100 also includes a lift arm structure 114 that is capable of being raised and lowered with respect to the frame 102. The lift arm structure 114 illustratively includes a lift arm 116 that is pivotally mounted to the frame 102 at joint 118. An actuator 120, which in some embodiments is a hydraulic cylinder configured to receive pressurized fluid from power conversion system 106, is pivotally coupled to both the frame 102 and the lift arm 116 at joints 122 and 124, respectively. Actuator 120 is sometimes referred to as a lift cylinder, and is a representative example of one type of actuator that may be used in a power machine 100. Extension and refraction of the actuator 120 causes the lift arm 116 to pivot about joint 118 such that an end of the lift arm 114 represented generally by a joint 132 (discussed in more detail below) is raised and lowered along a generally vertical path indicated approximately by arrow 138. The lift arm 116 is representative of one type of lift arm that may be attached to the power machine 100. The lift arm structure 114 shown in FIG. 1 includes a second lift arm and actuator disposed on an opposite side of the of the power machine 100, although neither is shown in FIG. 1. Other lift arm structures, with different geometries, components, and arrangements can be coupled to the power machine 100 or other power machines upon which the embodiments discussed herein can be practiced without departing from the scope of the present discussion. For example, power machines can have a lift arm such that joint 132 is raised in a generally radial path. Other power machines such as excavators and telehandlers have substantially different lift arm geometries as well as joints from those on the power machine 100 illustrated in FIG. 1.

An implement carrier 130 is pivotally mounted to the lift arm 116 at joint 132. One or more actuators such as hydraulic cylinder 136 are pivotally coupled to the implement carrier 130 and the lift arm structure 114 to cause the implement carrier to rotate under power about an axis that extends through the joint 132 in an arc approximated by arrow 128 in response to operator input. In some embodiments, the one or more actuators pivotally coupled to the implement carrier 130 and the lift arm assembly 114 is a hydraulic cylinder capable of receiving pressurized hydraulic fluid from the power conversion system 106. In these embodiments, the one or more hydraulic cylinders 136, which are sometimes referred to as tilt cylinders, are further representative examples of actuators that may be used in a power machine 100. An implement 152 in the form of a bucket is shown as being secured to the implement carrier 130 in FIG. 1. However, the implement carrier 130 is configured to accept and secure any one of a number of different implements to the power machine 100 as may be desired to accomplish a particular work task. Other power machines can have different types of implement carriers than the one shown in FIG. 1. Still other power machines do not have implement carriers and instead allow for implements that are directly attached to a lift arm.

A simple implement 152 in the form of a bucket 152 secured to the implement carrier 130. However, many other implements that include various actuators such as cylinders and motors, to name two examples, can also be secured to the implement carrier 130 to accomplish a variety of tasks. A partial list of the types of implements that can be secured to the implement carrier 130 includes augers, planers, graders, combination buckets, wheel saws, and the like. The power machine 100 provides a source, accessible at port 134, of power and control signals that can be coupled to an implement to control various functions on such an implement, in response to operator inputs. In one embodiment, port 134 includes hydraulic couplers that are connectable to an implement for providing power signals in the form of pressurized fluid provided by the power conversion system 106 for use by an implement that is operably coupled to the power machine 100. Alternatively or in addition, port 134 includes electrical connectors that can provide power signals and control signals to an implement to control and enable actuators of the type described above to control operation of functional components on an implement.

Power machine 100 also illustratively includes a cab 140 that is supported by the frame 102 and defines, at least in part, an operator compartment 142. Operator compartment 142 typically includes an operator seat, operator input devices, and display devices that are accessible and viewable from a sitting position in the seat (none of which are shown in FIG. 1). When an operator is seated properly within the operator compartment 142, the operator can manipulate operator input devices to control such functions as driving the power machine 100, raising and lowering the lift arm structure 114, rotating the implement carrier 130 about the lift arm structure 114 and make power and control signals available to implement via the sources available at port 134.

Power machine 150 also includes an electronic controller 150 that is configured to receive input signals from at least some of the operator input devices and provide control signals to the power conversion system 106 and to implements via port 134. It should be appreciated that electronic controller 150 can be a single electronic control device with instructions stored in a memory device and a processor that reads and executes the instructions to receive input signals and provide output signals all contained within a single enclosure. Alternatively, the electronic controller 150 can be implemented as a plurality of electronic devices coupled on a network. The disclosed embodiments are not limited to any single implementation of an electronic control device or devices. The electronic device or devices such as electronic controller 150 are programmed and configured by the stored instructions to function and operate as described.

Many power machines such as power machine 100 include a power conversion system that provides pressurized hydraulic fluid as an output to various actuators to perform various work tasks. One example of such an actuator is a motor and a more particular example is a drive motor. Drive motors receive pressurized hydraulic fluid and drive tractive elements such as tractive elements 108. Some drive motors have a moveable element that can be controlled to vary the displacement between a smaller displacement and a larger displacement. The moveable element in many of these drive motors is a swash plate that can be moved between a pair of stops to vary the motor displacement between the smaller and larger displacements. When a motor of this type has a larger displacement, a rotational output is characterized by lower rotational speeds and higher output torque. For the purposes of this discussion, having a drive motor oriented to have a larger (that is, a maximum) displacement is referred to as a low range condition. When a motor of this type has a smaller displacement, the rotational output is characterized by higher rotational speeds and lower output torque. For the purposes of this discussion, having a drive motor oriented toward a smaller (that is, a minimum) displacement is referred to as a high range condition.

A power machine that is able to make a trade-off between power (high torque) and speed in the low range and high range is more useful. In certain applications, such as digging, travel speed is unimportant while power is very important. An operator would likely never want to dig in high range. Conversely, when moving a power machine, speed is almost always more important than power and thus an operator would likely want to operate in high range. In some applications, though, a preferred orientation is a more balanced position between the low range and high range conditions. That is, an intermediate position, with less power but more speed than a low range position and conversely more power but less speed than a high range position is more preferred in some applications. The embodiments discussed below disclose a hydraulic motor with a moveable stop and a controller for controlling the moveable stop and the moveable element that moves between the stops (at least one of them being moveable) to accomplish low, high, and intermediate range positions. In other applications, a motor may be controlled similarly and used to power something other than tractive elements. For example, such a motor can be used on an implement that is coupled to, and receives power from, a power machine. Other applications are contemplated.

FIG. 2 is a block diagram illustrating a system 200 for providing a motor that can be operated at low, high, and intermediate range positions according to one embodiment. A motor 202 is provided, with motor 202 having a moveable element 204 and a moveable stop 206, each configured to receive a control signal from a displacement controller 208 that indicates a position or each of the moveable element and the moveable stop. The displacement controller 208 is in communication with one or more displacement control inputs 210 that provide input signals indicative of an intention to position the moveable element 204 and the moveable stop 206 and provides the control signals to position the moveable element and the moveable stop based on the input signals. The one or more displacement control inputs 210 are, in one embodiment, input devices that are manipulable by an operator, such as switches or other input devices. In other embodiments, the input devices are sensing devices that provide indications of operating conditions on the power machine. In still other embodiments, the displacement control inputs 210 include at least one manipulable operator input device and one sensing device indicative of an operating condition.

The motor 202 is provided pressurized fluid from a hydraulic power source 212 such as a pump. Pressurized hydraulic fluid may be provided from the hydraulic power source 212 to the displacement controller 208 to assist in positioning the motor 202. In addition, pressurized fluid is provided, in some embodiments, to the displacement control inputs 210 from the hydraulic power source. For example, the displacement control inputs 210 can be supplied hydraulic pressure (i.e. pilot pressure), which is selectively provided to the displacement controller 208 for positioning the moveable element 204 and moveable stop 206. Although FIG. 2 shows the hydraulic power source 212 as providing pressurized hydraulic fluid to both the displacement controller 208 and the displacement control inputs 210, in other embodiments, the hydraulic power source may provide pressurized hydraulic fluid to only one of the displacement controller 208 and the displacement control inputs 210, or neither.

FIGS. 3-5 illustrate a system 300 for providing a motor 310 that can be operated at low, high, and intermediate range positions according to one embodiment. System 300 includes, in addition to motor 310, one example of a hydraulic power source 320 that is capable of selectively providing pressurized hydraulic fluid to control operation of the motor 310, a displacement control system 330 that controls the operating displacement of the motor 310, and a low pressure hydraulic reservoir 340 (e.g., a tank) selectively communicating with the motor 310 and displacement control system 330. Parts or all of the displacement control system 330 can, but need not be, located within a housing that contains the motor 310.

The motor 310 and associated displacement control system 330 is of the type that can be operatively interconnected with one or more of the tractive elements 108 of the power machine 100, to drive the tractive elements 108 and cause travel of the power machine 100. As discussed above, commercial embodiments of various power machines include various arrangements and numbers of hydraulic drive motors that drive the tractive elements 108 on a particular power machine. The following disclosure will focus on a hydraulic motor 310, an associated hydraulic power source 320, and a displacement control system 330. Similar control systems to that shown in FIG. 2 would be required for each hydraulic motor similarly employed in a particular application (such as in power machine 100) or, alternatively, that elements of the hydraulic power source 320 and displacement control system 330 may be shared at least in part by multiple hydraulic motors 310 in a particular application. While the combination of hydraulic power source, hydraulic motor, and displacement control system are discussed in the context of drive motor applications, the disclosed embodiments can be employed in other applications, including, for example, implements that are attachable to power machines that have actuators in the form of hydraulic motors.

The illustrated motor 310 is a two-direction motor, capable of operating in forward and reverse directions. Motor 310 is also a variable displacement motor of the type described above that operates in a plurality of modes characterized by differing volumes of hydraulic fluid displaced through the motor 310 in each mode, including a low range mode (shown in FIG. 3), a high range mode (shown in FIG. 5), and an intermediate range mode (shown in FIG. 4).

In the low range mode, the motor 310 operates with maximum operating displacement of hydraulic fluid, which results in a low speed, high torque output. In the high range mode, the motor 310 operates with minimum operating displacement of hydraulic fluid, which results in a high speed, low torque output. In the intermediate range mode, the motor 310 operates with operating displacement, speed, and torque between the high and low range modes. As used in this specification, the term “operating displacement” means the hydraulic displacement (i.e. the available internal volume), and range of hydraulic displacements, at which the motor 310 is intended to operate for a given application. As such, “maximum operating displacement” and “minimum operating displacement” refer to the respective maximum and minimum displacement for which the motor 310 is designed, and not an absolute maximum or absolute minimum.

The motor 310 includes a movable element 350 that is positionable to dictate the operating mode (low, high, intermediate) of the motor 310. The form of the movable element 350 depends on the construction of the motor 310. For example, in a variable displacement axial piston motor, the movable element 350 is typically a swash plate. In the illustrated example, the movable element 350 is movable between a first position (shown in FIG. 3), which causes the motor 310 to operate in the low range mode, a second position (shown in FIG. 5), which causes the motor 310 to operate in the high range mode, and a third or intermediate position (shown in FIG. 4), which causes the motor 310 to operate in the intermediate range mode. The full range of motion of the movable element 350 is between the first and second positions.

The movable element 350 interengages with a fixed stop 360 when in the first position. In some embodiments, the movable element 350 may be biased into interengagement with the fixed stop 360. As used herein, the terms “interengage,” “interengagement”, and variations of those terms mean either direct or indirect engagement. Interengagement may occur through a linkage or through other elements and does not necessarily require direct engagement or abutment.

The hydraulic power source 320 communicates pressurized hydraulic fluid via a first output line 410 and a second output line 420 to the motor 310 in a loop. The hydraulic power source 320 is a bi-directional hydrostatic pump. In other embodiments, a hydraulic power source can employ other arrangements, including a hydraulic pump that provides pressurize fluid to a control valve that in turn ports oil as commanded via output lines to a motor. Various other arrangements can be used to provide a hydraulic power source for a motor of the type discussed herein.

The displacement control system 330 controls the position of the movable element 350 of the motor 310, and consequently controls the operating displacement of the motor 310. The displacement control system 330 includes a position controller 510, a positioning actuator 515, a range limiting actuator 520, and a movable stop 525. In some embodiments, the positioning actuator 515 and the range limiting actuator 520 portions of the displacement control system are integral to the motor 310. The displacement control system 330 and its components are not limited to any one physical configuration and can be located anywhere on a given power machine as may be advantageous. The position controller 510 is actuated to selectively energize the positioning actuator 515 and range limiting actuator 520 in response to an actuation signal. As will be discussed in more detail below, the positioning actuator 515 moves the movable element 350 of the motor 310 and the range limiting actuator 520 moves the movable stop 525. The positioning actuator 515 and range limiting actuator 520 may each include a single or multiple actuator elements, as will be discussed in more detail below.

The illustrated embodiment of the displacement control system 330 is hydraulically controlled in that the position controller 510 is a hydraulic valve assembly and the positioning actuator 515 and range limiting actuator 520 include linear hydraulic cylinders. In alternative embodiments, the displacement control system 330 may incorporate an electronic position controller (e.g., incorporated into the electronic controller 150), an electromechanical device (e.g., a solenoid) in place of the positioning actuator 515, an electromechanical device in place of the range limiting actuator 520, or any combination of hydraulic, electronic, electrohydraulic, and electromechanical components. Given that the displacement control system 330 can be embodied in hydraulic and electronic versions or in versions with both hydraulic and electronic components, all terminology describing the displacement control system 330 should be interpreted to cover any of these versions. For example, it was noted above that the position controller 510 selectively energizes the positioning actuator 515 and range limiting actuator 520. As used herein, the term “energize,” and its variations, means to supply hydraulic, electric, or other motive energy to an actuator.

The illustrated hydraulic position controller 510 is a shifting valve assembly that includes a positioning valve 530 and a range limiting valve 535. Both illustrated valves 530 and 535 are two-position hydraulic valves. In other embodiments, the position controller 510 could take the form of a single three-position hydraulic valve or could be an electronic controller with functionality for controlling the positioning actuator 515 and range limiting actuator 520. To account for all hydraulic and electronic versions of the position controller, the portions that control the positioning actuator 515 and range limiting actuator 520 (i.e., the positioning valve 530 and range limiting valve 535 in the illustrated embodiment) may generally be referred to as the respective positioning portion and range limiting portion of the position controller 510.

The positioning valve 530 is in communication with the first and second output lines 410 and 420 and the range limiting valve 535 communicates with the first and second output lines 410 and 420 through the positioning valve 530, thereby placing the range limiting valve 535 in sequence with the positioning valve 530, although the positioning and range limiting valves need not be in sequence. Both the positioning valve 530 and range limiting valve 535 also communicate with the low pressure reservoir 340.

Both the positioning valve 530 and range limiting valve 535 are movable between first positions (as shown in FIG. 3), to which they are biased by biasing mechanisms 532 and 536, respectively, and second positions. The range limiting valve 535 places the range limiting actuator 520 in communication with the positioning valve 530 in the first position (as shown in FIGS. 3-4), and with the low pressure reservoir 340 in the second position (as shown in FIG. 5). The positioning valve 530 places the positioning actuator 515 and range limiting valve 535 in communication with the low pressure reservoir 340 in the first position (as shown in FIG. 3), and with the first and second output lines 410 and 420 in the second position (as shown in FIGS. 4-5).

In the illustrated embodiment, the positioning actuator 515 includes a forward position actuator 540 and a reverse position actuator 545, and the range limiting actuator 520 includes a forward range limiting actuator 550 and a reverse range limiting actuator 555. The forward position actuator 540 and forward range limiting actuator 550 are selectively energized by hydraulic fluid from the first output line 410, which is the high-pressure side of the hydraulic loop when the motor 310 is operating in the forward direction and the low-pressure (albeit not zero pressure) side of the hydraulic loop when the motor 310 is operating in the reverse direction. The reverse position actuator 545 and reverse range limiting actuator 555 are selectively energized by hydraulic fluid from the second output line 420, which is the high-pressure side of the hydraulic loop when the motor 310 is operating in the reverse direction and the low-pressure (albeit not zero pressure) side of the hydraulic loop when the motor 310 is operating in the forward direction. In other embodiments, a single hydraulic actuator can be implemented for each of the positioning actuators 515 and range limiting actuator 540, along with a position controller that provides a positioning controller that provides a positioning signal regardless of which direction the motor 310 is being powered. In still other embodiments, electromechanical devices (e.g., solenoids) could replace the forward and reverse position actuators 540 and 545 and range limiting actuators 550 and 555.

As discussed above, the positioning valve 530 and the range limiting valve 535 are positioned in response to a displacement control input 370 that, in the embodiment shown in FIGS. 3-5 is a hydraulic pressure signal that is provided as an input to both the positioning valve 530 and the range limiting valve 535. In other embodiments, separate signals, including separate hydraulic signals can be provided to the positioning valve 530 and the range limiting valve 535. The displacement control input 370 in various other embodiments can take the form of a force in the form of hydraulic pressure or mechanical force from, for example, one or more linear actuators coupled to that is applicable to the positioning valve 530 and range limiting valve 535 or an electric signal provided to one or both of the positioning valve 530 and range limiting valve 535, the displacement control input 370 having arisen from manipulation of one or more operator input devices in the operator compartment 142. The displacement control input 370 can also arise from a pressure sensor that generates electric signals in response to certain hydraulic pressure conditions being met indicative of operating conditions on the power machine 100. The displacement control input 370 may have first, second, and third levels or states each of the levels or states being indicative of a mode of operation of the motor 310. In the configurations described below and illustrated, the first level of the displacement control input 370 is at a level that does not overcome either biasing mechanism 532 and 536, which permits the position controller 510 to be in a first condition, shown in FIG. 3, in which the motor 310 is in the low range mode.

In a hydraulic version of the position controller 510, the first, second, and third levels correlate to the hydraulic pressure of the displacement control input 370. In an electronic version of a position controller, the first, second, and third levels or states may correlate to discrete voltage levels, current levels, frequencies, or digital communication signals. Alternatively, in an electronic position controller, the second and third levels of the displacement control input 370 may be dedicated signals to one or both of the positioning valve 530 and range limiting valve 535. In another alternative electronic position controller, the second level of the displacement control input 370 may energize both the positioning actuator 515 and the range limiting actuator 520 and the third level of the displacement control input 370 may energize only the positioning actuator 515. It should not be assumed that the third level is higher or larger than the second or first level, or that the second level is higher or larger than the first level, and it should not be assumed that the levels occur in any prescribed order. The terms “first,” “second,” and “third” are used to indicate only that the signals are different from each other in some respect. The following description of the illustrated version of the position controller 510 is thus provided as one illustrative, non-limiting example.

FIG. 3 illustrates the configuration of the position controller 510 when the displacement control input 370 is at the first level. In this condition, both the positioning actuator 515 and range limiting actuator 520 are de-energized because they communicate with the low pressure reservoir 340. When de-energized, the positioning actuator 515 and range limiting actuator 520 are biased to the positions illustrated (e.g., their first positions). In this condition, the movable element 350 of the motor 310 is in the low range position, to which it is biased, and interengages the fixed stop 360.

FIG. 4 illustrates the configuration of the position controller 510 when the displacement control input 370 is at the third level. A displacement control input 370 of the third level shifts the positioning valve 530 to its second position, but does not shift the range limiting valve 535. In this condition, the position controller 510 energizes both the positioning actuator 515 and range limiting actuator 520. Consequently, the positioning actuator 515 moves the movable element 350 of the motor 310 and the range limiting actuator 520 moves the movable stop 525. The movable element 350 and movable stop 525 interengage to hold the movable element 350 at the intermediate position, resulting in intermediate range mode of operation of the motor 310. In some embodiments, the range limiting actuator 520 positions the movable stop 525 within the range of motion of the movable element 350, such that the movable element 350 directly engages the movable stop 525 at the intermediate position.

FIG. 5 illustrates the configuration of the position controller 510 when the displacement control input 370 is at the second level. A displacement control input 370 of the second level keeps the positioning valve 530 in its second position and shifts the range limiting valve 535 to its second position. In this configuration, the range limiting valve 535 places the range limiting actuator 520 in communication with the low pressure reservoir 340, such that the range limiting actuator 520 is de-energized. The positioning actuator 515 remains energized because it is still in communication with the output lines 410 and 420 through the positioning valve 530. As a consequence, the movable stop 525 and movable element 350 move to the second position, resulting in high range mode of operation of the motor 310.

The range limiting valve 535 can be adjustable to provide hydraulic fluid at a pressure that sets the intermediate position at a desired displacement level for the motor 310. In this regard, the range limiting valve 535 may be provided as a variable position valve that enables multiple third levels of the displacement control input 370 and multiple positions of the movable stop 525, to create multiple intermediate positions for the movable element 350. An electronic version of the displacement control system 330 can include an infinitely adjustable solenoid for positioning the movable stop 525 at the desired intermediate position. In all embodiments, the range limiting actuator 520 can be adjusted by the displacement control input 370 or other input that is a function of the system pressure, a function of a user input, or both. Additionally, the system may include a user override, whereby the operator of the power machine 100 can shift the displacement control system 330 to low range mode, high range mode, or intermediate range mode regardless of the displacement control input 370.

Referring now to FIG. 6, method for operating the motor 310 is described. The control logic may be executed by a controller, such as the electronic controller 150 of the power machine. At block 620 the displacement control input 370 is received by the controller 150 or a component in the displacement control system (e.g., the valves 530, 535 of the position controller 510). At block 630, the displacement control input 370 is compared to a first level.

If at block 630 the displacement control input 370 is at the first level, the motor 310 operates in the low range (i.e., high torque, low speed mode) at block 640. Operating at low range may include, for example, biasing the movable element 350 of the motor 310 to the first position with a biasing member, and de-energizing the positioning actuator 515 and range limiting actuator 520. If at block 630 the displacement control input 370 is not at the first level, the displacement control input 370 is compared to a second level at block 650.

If displacement control input 370 is at the second level, the motor 310 operates in the high range (i.e., low torque, high speed mode) at block 660. Operating at high range may include, for example, energizing the positioning actuator 515 and de-energizing the range limiting actuator 520 to position the movable element 350 in the second position (FIG. 5). If at block 650 the displacement control input 370 is not at the second level, the shift control is deemed to be at the third level and the method moves to block 670.

When the displacement control input 370 is deemed to be at the third level, and the motor operates in the intermediate range. Operating at the intermediate range may include energizing both the positioning actuator 515 and the range limiting actuator 520, such that the movable stop 525 interengages with the movable element 350 somewhere between the first and second positions.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. For example, in various embodiments, different types of power machines can be configured to implement the control valve assembly and power conversion systems and methods. Further, while particular control valve assembly configurations and work functions are illustrated, other valve configurations and types of work functions can also be used. Other examples of modifications of the disclosed concepts are also possible, without departing from the scope of the disclosed concepts.

What is claimed is:

1. A control system for a variable displacement hydraulic motor, the control system comprising:
a movable element that is movable in a range of motion between a first position and a second position, wherein one of the first and second positions corresponds to a maximum operating displacement of hydraulic fluid through the motor and the other of the first and second positions corresponds to a minimum operating displacement of hydraulic fluid through the motor;
a positioning actuator operable to move the movable element through the range of motion from the first position toward the second position;
a movable stop that is movable to a selected position for interengagement with the movable element to resist movement of the movable element past an intermediate position between the first and second positions, wherein the intermediate position of the movable element corresponds to an intermediate operating displacement of hydraulic fluid through the motor;
a range limiting actuator operable to move the movable stop to the selected position; and
a position controller operable to control the operation of the range limiting actuator.

2. The control system of claim 1, wherein the movable element is located within a housing of the hydraulic motor.

3. The control system of claim 1, wherein the movable element includes a swash plate.

4. The control system of claim 1, wherein the first position corresponds to the maximum operating displacement; and wherein the movable element is biased toward the first position.

5. The control system of claim 1, wherein the range limiting actuator positions the movable stop within the range of motion of the movable element, such that the movable element directly engages the movable stop at the intermediate position.

6. The control system of claim 1, wherein the position controller comprises an electronic controller receiving an input, determining a desired position of the positioning actuator and range limiting actuator based at least in part on the input, and generating an electric signal indicative of the desired positions of each of the positioning actuator and the range limiting actuator; and wherein the positioning actuator and the range limiting actuator operate in response to the electric signal.

7. The control system of claim 1, wherein the positioning actuator and range limiting actuator are hydraulic actuators; and wherein the position controller comprises a shifting valve assembly that includes a range limiting portion selectively supplying hydraulic fluid to operate the range limiting actuator, and a positioning portion selectively supplying hydraulic fluid to control operation of the positioning actuator.

8. The control system of claim 7, wherein the range limiting actuator includes first and second cylinders linearly shiftable under the influence of hydraulic fluid; wherein the range limiting portion of the shifting valve assembly selectively supplies hydraulic fluid to the first cylinder when the motor is run in a first operating direction and to the second cylinder when the motor is run in a second operating direction.

9. The control system of claim 7, wherein the positioning portion of the shifting valve assembly comprises a two-position valve communicating with the positioning actuator; and wherein the range limiting portion comprises a two-position valve communicating with the range limiting actuator, the two-position valve of the range limiting portion being separate from the two-position valve of the positioning portion.

10. The control system of claim 7, wherein the range limiting portion of the shifting valve assembly is a variable position valve that enables multiple positions of the movable stop to create multiple intermediate positions for the movable element.

11. The control system of claim 7, wherein the shifting valve assembly operates in response to a hydraulic fluid pressure; wherein at a first hydraulic fluid pressure the positioning actuator and range limiting actuator communicate through the shifting valve assembly with a low pressure reservoir; wherein at a second hydraulic fluid pressure, different from the first hydraulic fluid pressure, the shifting valve assembly supplies hydraulic fluid to both the positioning actuator and the range limiting actuator; and wherein at a third hydraulic fluid pressure, different from the first and second hydraulic fluid pressures, the shifting valve assembly supplies hydraulic fluid to the positioning actuator and places the range limiting actuator in communication with the low pressure reservoir.

12. A power machine comprising:
a power source;
a power conversion system converting power from the power source into flow of a hydraulic fluid;
a drive system utilizing the hydraulic fluid to move the power machine between locations, the drive system including a variable displacement drive motor; and
a drive motor control system comprising:
a movable element that is movable in a range of motion between a first position and a second position, wherein one of the first and second positions corresponds to a maximum operating displacement of hydraulic fluid through the motor, and the other of the first and second positions corresponds to a minimum operating displacement of hydraulic fluid through the motor;
a positioning actuator operable to move the movable element through the range of motion from the first position toward the second position;
a movable stop that is movable to a selected position for interengagement with the movable element to resist movement of the movable element past an intermediate position between the first and second positions, wherein the intermediate position of the movable element corresponds to an intermediate operating displacement of hydraulic fluid through the motor;
a range limiting actuator operable to move the movable stop to the selected position; and
a position controller operable to control the operation of the range limiting actuator.

13. The power machine of claim 12, wherein the movable element is located within a housing of the hydraulic motor.

14. The power machine of claim 12, wherein the first position corresponds to the maximum operating displacement; and wherein the movable element is biased toward the first position.

15. The power machine of claim 12, wherein the range limiting actuator positions the movable stop within the range of motion of the movable element, such that the movable element directly engages the movable stop at the intermediate position.

16. The power machine of claim 12, further comprising a pressure sensor, wherein the position controller operates in response to signals from the pressure sensor.

17. The power machine of claim 12, wherein the position controller operates in response to an electric displacement control input.

18. The power machine of claim 12, wherein the position controller comprises an electronic controller receiving an input, determining a desired position of the range limiting actuator based at least in part on the input, and generating an electric signal indicative of the desired position of the range limiting actuator in response to the electric signal.

19. The power machine of claim 12, wherein the position controller is further operable to control the operation of the positioning actuator.

20. The power machine of claim 19, wherein the positioning actuator and the range limiting actuator are hydraulic actuators; and wherein the position controller includes a shifting valve assembly with a positioning portion selectively supplying hydraulic fluid to operate the positioning actuator, and a range limiting portion selectively supplying hydraulic fluid to operate the range limiting actuator.

21. The power machine of claim 20, wherein the range limiting portion of the shifting valve assembly is a variable position valve that enables multiple positions of the movable stop to create multiple intermediate positions for the movable element.

22. The power machine of claim 20, wherein the shifting valve assembly operates in response to a hydraulic fluid pressure; wherein at a first hydraulic fluid pressure the positioning actuator and range limiting actuator communicate through the shifting valve assembly with a low pressure reservoir; wherein at a second hydraulic fluid pressure, different from the first hydraulic fluid pressure, the shifting valve assembly supplies hydraulic fluid to both the positioning actuator and the range limiting actuator; and wherein at a third hydraulic fluid pressure, different from the first and second hydraulic fluid pressures, the shifting valve assembly supplies hydraulic fluid to the positioning actuator and places the range limiting actuator in communication with the low pressure reservoir.

23. A method for operating a variable displacement hydraulic motor that includes a movable element that is movable to a first position to operate the motor at maximum operating displacement of hydraulic fluid through the motor and a second position to operate the motor at minimum operating displacement of hydraulic fluid through the motor, the method comprising:
providing a displacement control input;
in response to a first level of the displacement control input, shifting the movable element to the first position, such that the motor operates in a high torque, low speed mode;
in response to a second level of the displacement control input, shifting the movable element to the second position, such that the motor operates in a low torque, high speed mode; and
in response to a third level of the displacement control input between the first and second levels, positioning a movable stop to resist movement of the movable element past a third position between the first and second positions, such that the motor operates in an intermediate torque, intermediate speed mode.

24. The method of claim 23, wherein positioning a movable stop includes positioning the movable stop for direct engagement with the movable element at the third position.

25. The method of claim 23, wherein providing a displacement control input includes providing a pressure signal.

26. The method of claim 23, wherein providing a displacement control input includes providing an electric signal; and wherein shifting the movable element to the second position includes shifting the movable element with a solenoid.

27. The method of claim 23, wherein shifting the movable element to the first position includes biasing the movable element to the first position with a biasing member.

28. The method of claim 23, wherein shifting the movable element to the second position includes actuating a hydraulic actuator.

29. A control system for a variable displacement hydraulic motor, the control system comprising:
a movable element that is movable in a range of motion between a first position and a second position, wherein one of the first and second positions corresponds to a maximum operating displacement of hydraulic fluid through the motor and the other of the first and second positions corresponds to a minimum operating displacement of hydraulic fluid through the motor;
a positioning actuator to move the movable element through a range of motion from the first position to the second position;
a range limiting actuator;
a movable stop interconnected with the range limiting actuator; and
shifting means for causing the positioning actuator to move the movable element through the range of motion, and for causing the range limiting actuator to position the movable stop in a desired position;
wherein interengagement of the movable element with the movable stop resists movement of the movable element past an intermediate position between the first and second positions, wherein the intermediate position of the movable element corresponds to an intermediate operating displacement of hydraulic fluid through the motor.
